(19) United States
(12) Patent Application Publication
(10) Pub. No.: US 2016/0007189 A1
(43) Pub. Date: Jan. 7, 2016

(54) NEAR FIELD WIRELESS COMMUNICATION APPARATUS

(71) Applicant: DENSO CORPORATION, Kariya-city, Aichi (JP)

(72) Inventor: Masashi MIURA, Toyota-city (JP)

(21) Appl. No.: 14/768,175

(22) PCT Filed: Jan. 27, 2014
(86) PCT No.: PCT/JP2014/000382

§ 371 Date: Aug. 14, 2015

(30) Foreign Application Priority Data
Feb. 19, 2013 (JP) 2013-029996

(51) Int. Cl. H04W 8/20; H04W 4/00; H04B 5/00; H04M 1/725

(52) U.S. Cl. CPC H04W 8/205; H04M 1/7253; H04W 4/008; H04B 5/0031

(57) ABSTRACT

A near field wireless communication apparatus includes a storage storing apparatus side phone book data, a connecting section connectable with a partner terminal device, which stores device side phone book data, under a predetermined protocol, and a controller. The controller acquires the device side phone book data from the partner terminal device under a condition that the partner terminal device is in a connectable state with the connecting section under the predetermined protocol, and compares the device side phone book data with the apparatus side phone book data stored in the storage. When determining that a concordance rate between the device side phone book data and the apparatus side phone book data is equal to or higher than a threshold level, the controller connects the partner terminal device with the connecting section under the predetermined protocol.

### CROSS REFERENCE TO RELATED APPLICATION

This application is based on Japanese Patent Application No. 2013-029996 filed on Feb. 19, 2013, the disclosure of which is incorporated herein by reference.

### TECHNICAL FIELD

The present disclosure relates to a near field wireless communication apparatus including a storage in which phone book data is stored.

### BACKGROUND ART

A near field wireless communication apparatus has been put into practice for providing an application, which operates based on a predetermined protocol, in cooperation with a partner terminal device by establishing the predetermined protocol with the partner terminal device. For example, in patent literature 1, under a condition that Bluetooth (registered trademark) (hereinafter, referred to as BT) line is established between a vehicular hands free apparatus and a mobile phone, and the vehicular hands free apparatus is further connected with the mobile phone under HFP (Hands Free Profile). Then, calls on the mobile phone can be made in hands free manner using the vehicular hands free apparatus.

In some cases, there are one or more passengers get into the vehicle together with the driver, and each of passengers and the driver may carry an own mobile phone. Thus, multiple mobile phones may exist together with one hands free apparatus in the compartment of the vehicle, and the hands free apparatus may face a difficulty in selecting with which mobile phone HFP should be connected. In this case, as a first method, the hands free apparatus may refer to a BT line connection history, and selects one or more target mobile phones for the connection of HFP. When selecting the target mobile phone, the hands free apparatus may try BT line establishment on each of the mobile phones in time reversed order from the latest mobile phone with which the BT line is connected latest. When the BT line establishment succeeds with one mobile phone, the hands free apparatus may make a connection with the mobile phone under HFP. Further, as a second method, information of owner may be preliminarily registered in both the mobile phone and the hands free apparatus, and the hands free apparatus may make a connection under HFP with the mobile phone that has the same owner information.

However, in the above-described first method, the connection history of BT line with the mobile phones is required to be stored in the hands free apparatus. Thus, memory for storing the BT line connection history is additionally required and process for selecting the mobile phone is required to be carried out by the hands free apparatus. In the second method, the owner information needs to be stored both in the hands free apparatus and the mobile phone. When the registration of owner information is not performed on the mobile phone or on the hands free apparatus by forgetfulness of the user or wrong information is registered caused by carelessness made by the user, the hands free apparatus may fail to make a connection with the mobile phone under HFP.

### PRIOR ART LITERATURES

### Patent Literature

Patent literature 1: JP 2007-266755 A

### SUMMARY OF INVENTION

In view of the foregoing difficulties, it is an object of the present disclosure to provide a near field wireless communication apparatus which improves a convenience for user by easily specifying a target partner terminal device and properly connecting with the target partner terminal device under a predetermined protocol.

According to an aspect of the present disclosure, a near field wireless communication apparatus includes a storage storing apparatus side phone book data, a connecting section connectable with a partner terminal device, which stores device side phone book data, under a predetermined protocol, and a controller. The controller acquires the device side phone book data from the partner terminal device under a condition that the partner terminal device is in a connectable state with the connecting section under the predetermined protocol, and compares the device side phone book data with the apparatus side phone book data stored in the storage. When determining that a concordance rate between the device side phone book data and the apparatus side phone book data is equal to or higher than a threshold level, the controller connects the partner terminal device with the connecting section under the predetermined protocol.

With the above apparatus, a target partner terminal device with which a connection should be made under a predetermined protocol can be easily specified and the predetermined protocol can be properly connected with the specified target partner terminal device, and accordingly, convenience for user can be improved.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram showing functional blocks of a near field wireless communication apparatus according to an embodiment of the present disclosure;

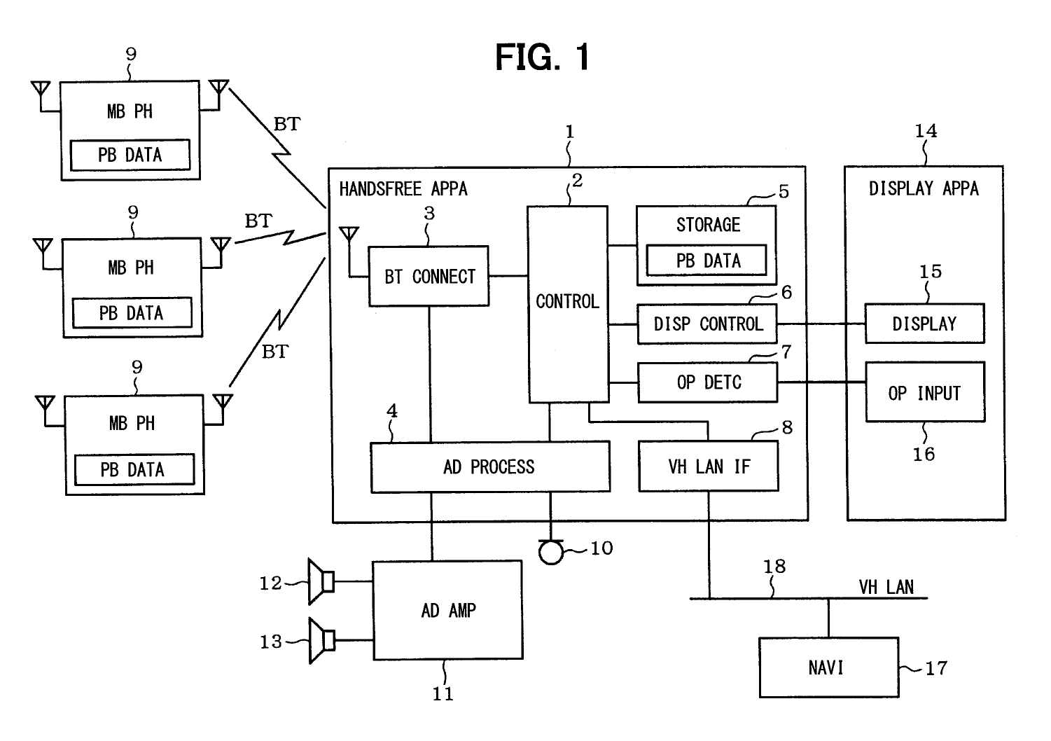

FIG. 2 is a flowchart showing a process executed by the near field wireless communication apparatus;

FIG. 3 is a diagram showing an example for connecting a profile between a hands free apparatus and a mobile phone;

FIG. 4 is a diagram showing an example for connecting a profile between a hands free apparatus and multiple mobile phones;

FIG. 5 is a diagram showing an example for connecting a profile between a hands free apparatus and a mobile phone when one of multiple phone book data is selectable as a comparison target in the hands free apparatus;

FIG. 6 is a diagram showing an example for connecting a profile between a hands free apparatus and a mobile phone when multiple mobile phones are detected and the multiple mobile phones have respective phone book data whose concordance rates with apparatus side phone book data are equal to or higher than a threshold level; and

FIG. 7 is a diagram showing examples of the profile that is connected between a hands free apparatus and a mobile phone.

### EMBODIMENTS FOR CARRYING OUT INVENTION

The following will describe a near field wireless communication apparatus according to the present disclosure with reference to the accompanying drawings. In an embodiment of the present disclosure, the near field wireless communication is applied to a vehicular hands free apparatus. The hands free apparatus (HANDSFREE APPA) 1 includes a controller (CONTROL) 2, a Bluetooth (registered trademark) connecting section 3 (BT CONNECT), a voice call audio processor (AD PROCESS) 4, a storage (STORAGE) 5, a display controller (DISP CONTROL) 6, an operation detector (OP DETC) 7, and a vehicle Local Area Network interface (VH LAN IF) 8. Hereinafter, Bluetooth is referred to as BT, and the vehicle Local Area

Network interface is referred to as vehicle LAN IF.

The controller 2 is provided by a well-known microcomputer including CPU, RAM, ROM, and I/O bus or the like. The controller 2 performs overall control to the hands free apparatus 1 including operations related to telecommunication and data management. When a BT supported communication device is carried into a compartment of a vehicle, the BT connecting section 3 is able to establish a BT line between itself and the communication device. Further, under a condition that the communication device is in BT connected state, the BT connecting section 3 is further able to make connection with the communication device under various kinds of profiles (predetermined profile), which are defined under BT standard. For example, the profiles defined under BT standard may include PBAP (Phone Book Access Profile), OPP (Object Push Profile), HFP (Hands Free Profile), MAP(Message Access Profile), A2DP (Advanced Audio Distribution Profile), AVRCP (Audio/Video Remote Control Profile), SPP (Serial Port Profile), DUN (Dial-up Networking Profile), and PAN (Personal Area Network Profile). The BT connecting section 3 functions as a connecting section.

PBAP and OPP are profiles which define transmission of phone book data. HFP is a profile for providing a function of handsfree telephone call. MAP is a profile which defines transmission of electronic mail data. A2DP is a profile which defines transmission of audio data. AVRCP is a profile which defines transmission of control commands of audio data. SPP is a profile which defines the data communication under the virtual serial port. DUN is a profile which defines a dial-up connection to the Internet. PAN is a profile for providing a small-scale network.

The voice call audio processor 4 is connected with a microphone 10 disposed, for example, at a portion in the compartment of the vehicle so that audio signals made by a user who is seated near the steering wheel of the vehicle is easily collected by the microphone 10. Further, the voice call audio processor 4 is connected with an audio amplifier (AD AMP) 11 disposed separated from the hands free apparatus 1. The audio amplifier 11 is connected with two speakers 12 and 13.

The storage 5 is configured to store various kinds of data. For example, the storage 5 stores phone book data (PB DATA) that includes multiple phone book data records (for example, 500 records in maximum). Each record of phone book data includes, for example, registration name (full name or appellation), phone number, and electronic mail address. Hereinafter, the phone book data stored in the storage 5 is referred to as apparatus side phone book data. The storage 5 further stores outgoing history data indicating history of outgoing calls from the mobile phone (MB PH) 9 connected with the hands free apparatus 1 under HFP. The storage 5 further stores incoming history data indicating history of incoming calls to the mobile phone (MB PH) 9 connected with the hands free apparatus 1 under HFP. The storage 5 is further capable of storing device information (such as phone number) of partner communication device as communication device information. The partner communication device is a partner side device with which the BT connecting section 3 is connected via BT line.

A display apparatus (DISPLAY APPA) 14 includes a display section (DISPLAY) 15 and a touch operation input section (OP INPUT) 16. The display section 15 displays various kinds of display windows, such as a menu window, an outgoing call window, and an incoming call window. The operation input section 15 is provided by touch buttons displayed on a display window. When the controller 2 outputs a display command signal to the display controller 6, the display controller 6 controls the display section 15 to display an image according to the display command signal. When a user makes an operation on the touch button displayed on the display window, the touch operation input section 16 outputs an operation signal to the operation detector 7, and the operation detector 7 outputs the operation signal to the controller 2. Then, the controller 2 analyzes the operation signal.

The vehicle LAN IF 8 is connected with a navigation system (NAVI) 17, which is equipped to a vehicle, via a vehicle LAN (VH LAN) 18. The navigation system 17 has well-known navigating functions, such as specifying a position of the vehicle, reading out road map data from a database, matching the vehicle position on the road map data, setting a destination, searching for a route from the vehicle position to the destination, guiding the vehicle to the destination along the searched route, and drawing graphs for the vehicle position and the route.

The controller 2 switches an operation state of the hands free apparatus 1 between a normal state and a low power consumption state according to a turning on or turning off of an ACC (accessory) switch. That is, when the ACC switch is in off state, the controller 2 controls the hands free apparatus 1 to operate in the low power consumption state by controlling a current flowing from a vehicle battery (not shown) to the hands free apparatus 1 lower than a current flowing in the normal state. Then, the controller 2 monitors a turning on of the ACC switch from the off state to the on state. When the ACC switch is turned on from the off state to the on state by a user, the controller 2 increases the current flowing from the vehicle battery to the hands free apparatus 1 to a normal current level for controlling the hands free apparatus 1 to operate in the normal state.

The mobile phone 9 is a device with which the BT connecting section 3 of the hands free apparatus 3 is connectable via BT line. The mobile phone 9 is capable of making telephone calls by establishing a wide area telephone line with a telecommunication network. The mobile phone 9 is capable of performing BT communication with the hands free apparatus 1 by establishing BT line with the hands free apparatus 1. The mobile phone 9 is capable of receiving operations made by a user and displaying various kinds of display windows. The mobile phone 9 is capable of receiving audio signal made by the user via a microphone and transmitting the audio signal to a telephone call partner. The mobile phone 9 is also capable of outputting the audio signal transmitted from the telephone call partner via the telecommunication network to the user using a speaker. Further, similar to the hands free apparatus 1, the mobile phone 9 is capable of storing the phone book data including multiple phone book data records (for example, 200 records in maximum). Each record of the phone book data may include, for example, registration name, phone number, and electronic mail address. Hereinafter, the phone book data stored in the mobile phone 9 is also referred to as device side phone book data.

A voice call mode of the mobile phone 9 can switch between handset mode and hands free mode. When the mobile phone 9 is in HFP disconnected state with the hands free apparatus 1 and the voice call mode is set as the handset mode, the mobile phone 9 activates the microphone and the speaker of the own device (connect the audio path). In this case, the mobile phone 9 receives and outputs the audio signal transmitted from the telephone of the voice call partner via the telecommunication network, and transmits, to the telecommunication network, the audio signal made by the user and collected by the microphone of the own device. When the mobile phone 9 is in HFP connected state with the hands free apparatus 1 and the voice call mode is set as the hands free mode, the mobile phone 9 deactivates the microphone and the speaker of the own device (disconnect the audio path). Then, the mobile phone 9 transmits the audio signal to the hands free apparatus 1. In this case, the mobile phone 9 transmits the audio signal, which is transmitted from the telephone of the voice call partner via the telecommunication network, to the hands free apparatus 1 via the BT line, and the hands free apparatus 1 outputs the audio signal using the speakers 12, 13. At the same time, the mobile phone 9 receives the audio signal made by the user. Herein, the audio signal is collected by the microphone 10 of the hands free apparatus 1 and is transmitted from the hands free apparatus via the BT line. Then, the mobile phone 9 transmits the audio signal of the user to the voice call partner via the telecommunication network.

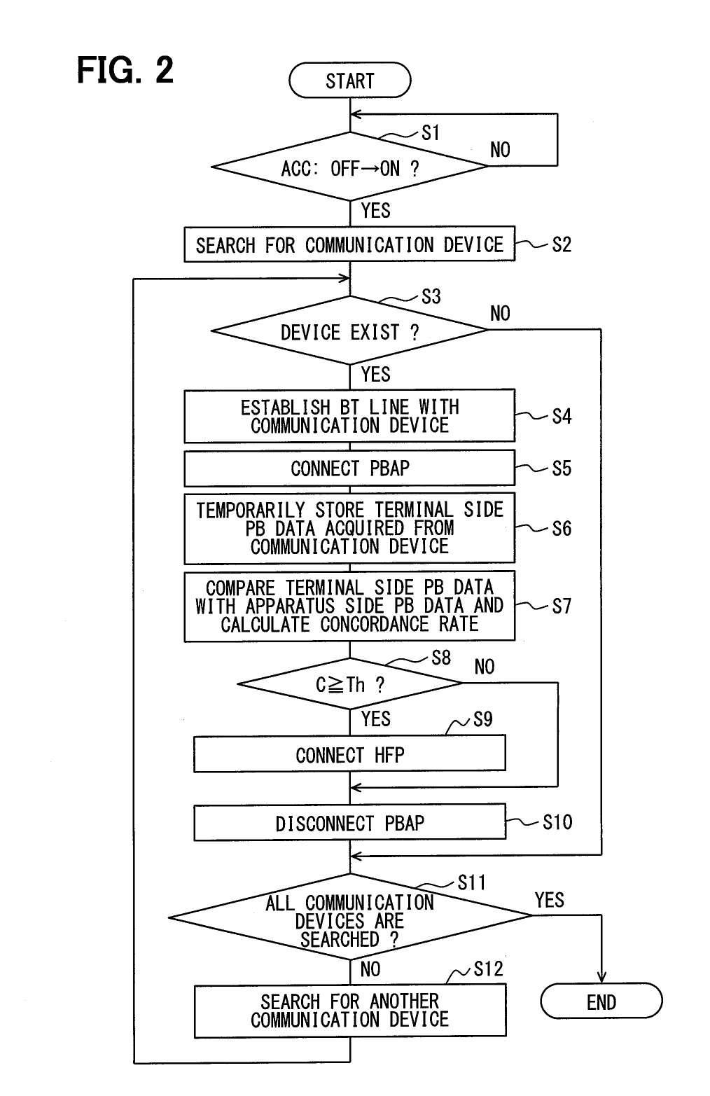

The following will describe an operation of above-described configuration with reference to FIG. 2 to FIG. 7. The controller 2 executes the process shown in FIG. 2. In the following example, the BT connecting section 3 is able to simultaneously connect with multiple (two or more) communication devices under HFP. That is, the BT connecting section 3 is able to perform multiple connection.

It is noted that a flowchart or the processing of the flowchart in the present disclosure includes sections (also referred to as steps), each of which is represented, for instance, as S1. Further, each section can be divided into several sub-sections while several sections can be combined into a single section. Furthermore, each of thus configured sections can be also referred to as a circuit, device, module, or means.

In the hands free apparatus 1, when the controller 2 determines that the ACC switch is turned on from the off state (S1: YES), the operation state of the hands free apparatus 1 switches from the low power consumption state to the normal state. Then, the controller 2 searches for, according to the communication device information stored in the storage 5, a communication device that is connectable with the BT connecting section 3 via the BT line (S2). In a case where the device information of the mobile phone 9 carried into the compartment of the vehicle has already been stored in the storage 5 as the communication device information, the controller 2 may succeed in searching for the target mobile phone 9. In a case where the device information of the mobile phone 9 carried into the compartment of the vehicle has not been stored in the storage 5 as the communication device information, the controller 2 may fail to search for the mobile phone 9.

When the controller 2 determines that the searching of the target communication device has succeeded (S3: YES), the controller 2 establishes the BT line between the BT connecting section 3 and the communication device (S4). Then, the controller 2 connects PBAP between the BT connecting section 3 and the communication device with which the BT line has been established. Then, the controller 2 outputs a transmission request of the phone book data via the BT connecting section 3 to the communication device with which PBAP has been connected in order to control the communication device to transmit the phone book data stored in the own device to the controller 2 (that is, takes a copy of the phone book data from the communication device) (S5). When acquiring the phone book data from the communication device by controlling the communication device to transmit the phone book data, the controller 2 temporarily stores acquired phone book data (S6).

The controller 2 compares the temporarily stored phone book data, which is identical to the phone book data initially stored in the communication device, with the phone book data stored in the storage 5, and calculates a concordance rate (C) between the two phone book data (S7). The following will describe details of calculation of the concordance rate by the controller 2. Usually, registering of the phone book data (contents of registration information) may be carried out by the user in various kinds of methods. For example, the full name registered on an official family registry may be set as the registration name or the appellation, such as nickname, may be set as the registration name. The registration name may be spelled in Kanji characters, Hiragana characters, or English alphabets. Both the phone number and the electronic mail address can be registered in relation to the registration name. As another example, only the phone number may be registered in relation to the registration name without registering the electronic mail address. One record of phone number may be registered in relation to one registration name. As another example, multiple records of phone number may be registered in relation to one registration name. As described above, one record of phone book data related to one person may have different registration name or different number of phone number records or different number of electronic mail addresses from another one record of phone book data related to the same person. Further, the total number of phone book data records in the communication device may be different from the total number of phone book data records in the storage 5 of the hands free apparatus 1.

With consideration of above-described difficulties, the present disclosure compares only the phone number regardless of the user who uses the phone book data. This is because, the phone number is always designated for the corresponding communication device and does not change regardless of the user who edits the phone book data (that is, the phone number has no variation even when inputted by different persons). The controller 2 counts the quantity of identical phone number records in the phone book data of the communication device. Herein identical phone number records are the phone number records which are identical to the phone number records in the phone book data of the storage 5. Then, the controller 2 calculates, as the concordance rate, a ratio of the quantity of the identical phone number records to the total quantity of the phone book data records included in the phone book data of the storage 5. Suppose that the quantity of phone number records included in the phone book data of the communication device, which are identical to the phone number records included in the phone book data stored in the storage 5, is “30” and the total quantity of the phone book data records included in the phone book data stored in the storage 5 is “50”. In this case, the concordance rate is calculated as 30/50=0.6.

The controller 28 compares the calculated concordance rate with a preliminarily set threshold level (Th) (S8). When the controller 2 determines that the concordance rate is equal to or higher than the threshold level (S8: YES), the controller 2 connects HFP between the BT connecting section 3 and the communication device with which the BT line has been established (S9). At the same time, the controller 2 disconnects PBAP which is in the connected state between the communication device and the BT connecting section 3 (S10). When the controller 2 determines that the concordance rate is lower than the threshold level (S8: NO), the controller 2 disconnects PBAP which is in the connected state between the communication device and the BT connecting section 3 without connecting HFP between the connecting section 3 and the communication device.

The controller 2 determines whether all of the communication devices, whose communication device information is stored in the storage 5, have been searched (S11). When the controller 2 determines that only a part of the communication devices, whose communication device information is stored in the storage 5, have been searched (S11: NO), the controller 2 searches for another communication device (a device yet searched for) which is connectable with the BT connecting section 3 via BT line according to the communication device information stored in the storage 5 (S12), and repeatedly execute the process from S3.

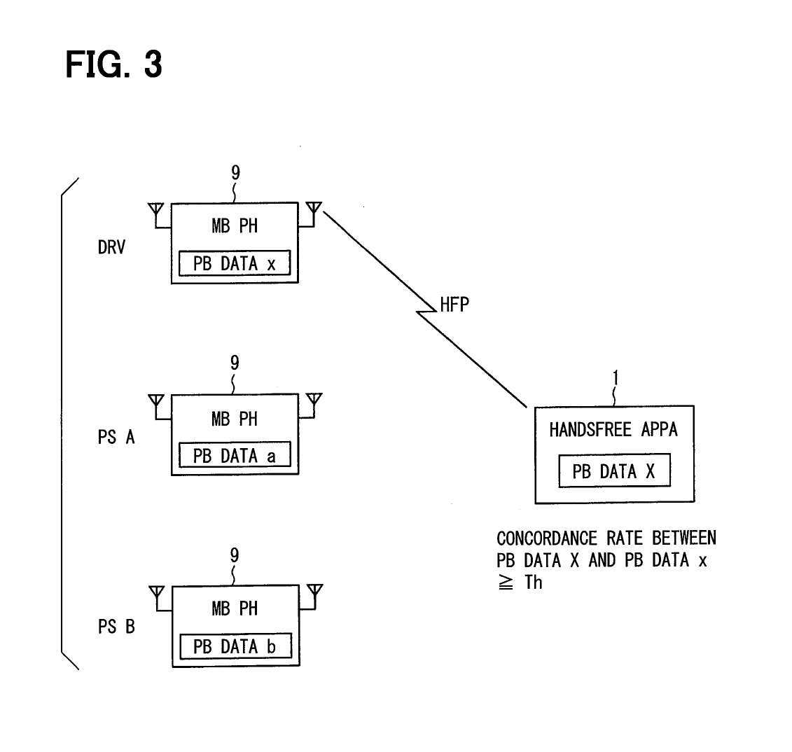

The controller 2 executes above-described process for performing the following operation in a case where multiple mobile phones 9 are carried into the compartment of the vehicle as the communication devices. As shown in FIG. 3, suppose that three persons including, for example, a driver (DRV), a passenger (PS) A, a passenger (PS) B get into the vehicle and each person has one mobile phone 9. When the hands free apparatus 1 determines that the concordance rate between the phone book data X of the hands free apparatus 1 and the phone book x of the mobile phone 9 carried by the driver is equal to or higher than the threshold level, the hands free apparatus 1 connects with the mobile phone 9 carried by the driver under HFP. When the hands free apparatus 1 determines that the concordance rate between the phone book data X of the hands free apparatus 1 and the phone book data a of the mobile phone 9 carried by the passenger A is lower than the threshold level, the hands free apparatus 1 does not connect with the mobile phone 9 carried by the passenger A under HFP. Similarly, when the hands free apparatus 1 determines that the concordance rate between the phone book data X of the hands free apparatus 1 and the phone book data b of the mobile phone 9 carried by the passenger B is lower than the threshold level, the hands free apparatus 1 does not connect HFP with the mobile phone 9 carried by the passenger B. With this configuration, only the driver is able to perform the hands free calling (hands free calling also includes a standby state for waiting a hands free incoming call or a hands free outgoing call) for the voice calls made on the mobile phone 9. That is, the driver only needs to synchronize the phone book data stored in his or her own mobile phone 9 with the hands free apparatus 1 by once (preliminarily copying the phone book data) in order to use his or her own mobile phone 9 in hands free manner.

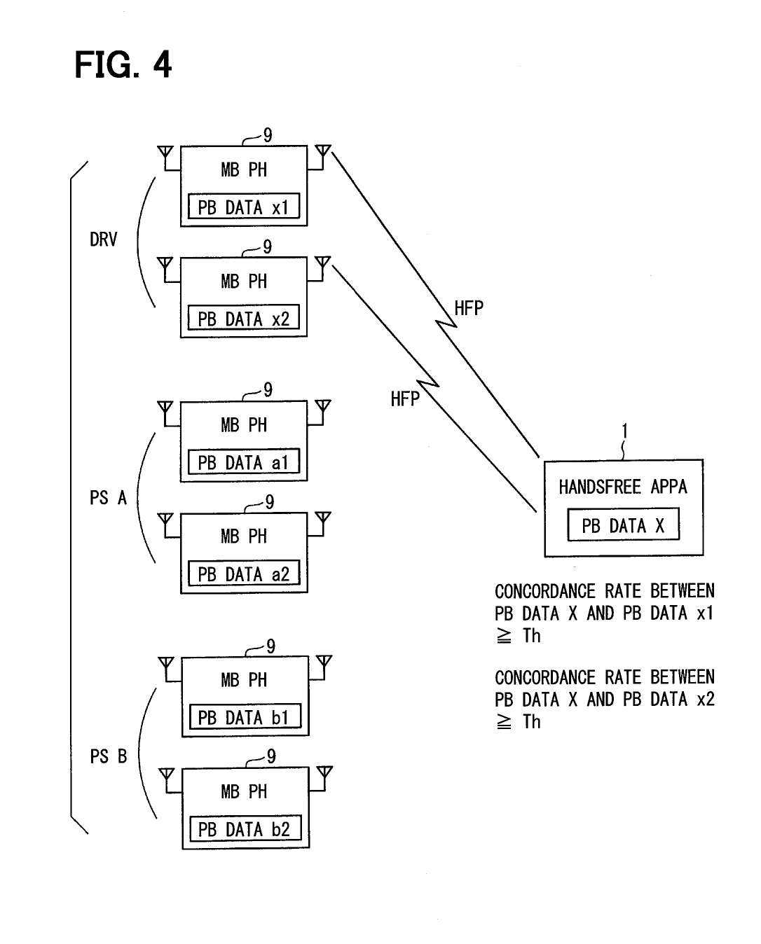

As shown in FIG. 4, suppose that three persons including, for example, a driver, a passenger A, a passenger B get into the vehicle and each person has two mobile phones 9 (one of the two mobile phones 9 may be for use in private purpose and the other one of the two mobile phones 9 may be for use with work). When the hands free apparatus 1 determines that the concordance rate between the phone book data X of the hands free apparatus 1 and the phone book data xl of one mobile phone 9 carried by the driver is equal to or higher than the threshold level, the hands free apparatus 1 connects with the one mobile phone 9 carried by the driver under HFP. Further, when the hands free apparatus 1 determines that the concordance rate between the phone book data X of the hands free apparatus 1 and the phone book data x2 of the other mobile phone 9 carried by the driver is also equal to or higher than the threshold level, the hands free apparatus 1 further connects with the other mobile phone 9 carried by the driver under HFP. When the hands free apparatus 1 determines that the concordance rate between the phone book data X of the hands free apparatus 1 and any one phone book data (phone book data a1, a2, b1, b2 in FIG. 4) of the mobile phone 9 carried by one passenger other than the driver is lower than the threshold level, the hands free apparatus 1 does not connect with the mobile phone 9 carried by the passenger under HFP. With this configuration, only the driver is able to perform the hands free call using his or her two mobile phones 9 under HFP.

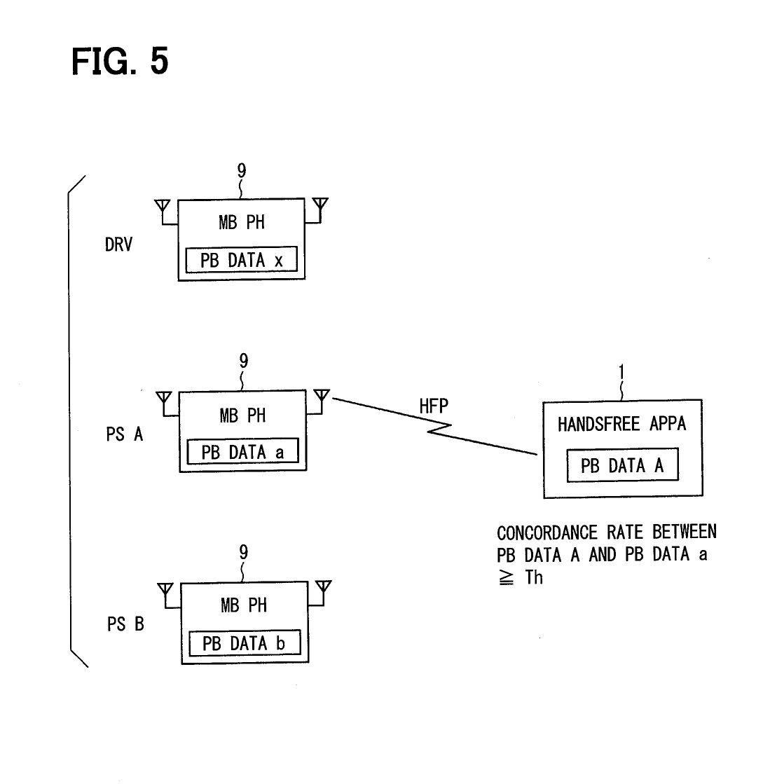

When the storage 5 of the hands free apparatus 1 is able to store multiple sets of phone book data, one of the multiple sets of the phone book data may be selected as the comparison target. For example, when the controller 2 determines that the operation for selecting (switching) one of the multiple sets of the phone book data as the comparison target is made by the user using the touch operation input section 16, the controller 2 selects, according to the operation made by the user, one of the multiple sets of the phone book data stored in the storage 5 as the comparison target. As shown in FIG. 5, when the comparison target is changed from the phone book data X to the phone book data A by the user, the controller 2 compares the phone book data A stored in the hands free apparatus 1 with the phone book data a stored in the mobile phone 9 carried by the passenger A. When the concordance rate is equal to or higher than the threshold level, the hands free apparatus 1 connects with the mobile phone 9 carried by the passenger A under HFP. Suppose that the concordance rate between the phone book data A of the hands free apparatus 1 and the phone book data x of the mobile phone 9 carried by the driver is not equal to or higher than the threshold level and the concordance rate between the phone book data A of the hands free apparatus 1 and the phone book data b of the mobile phone 9 carried by the passenger B is not equal to or higher than the threshold level. In this case, the hands free apparatus 1 does not connect with the mobile phone 9 carried by the driver or the mobile phone 9 carried by the passenger

B under HFP. With this configuration, only the passenger A, instead of the driver, is able to use the hands free call function on his or her own mobile phone 9. That is, at first, the driver is able to use hands free call function on his or her own mobile phone 9. When the change of the comparison target from the phone book data X to the phone book data A is carried out after the passenger A gets into the vehicle, the passenger A is able to use hands free call function on his or her own mobile phone 9. When the change of the comparison target from the phone book data X to the phone book data A is carried out before the passenger A gets into the vehicle (for example, immediately after the last getting out from the vehicle), the passenger A is able to use hands free call function on his or her own mobile phone 9 right after getting into the vehicle. The change of the phone book data which functions as the comparison target may be carried out by the user using the touch operation input section 16 as described above. As another example, speech recognition technology may also be used in order to change the phone book data which functions as the comparison target.

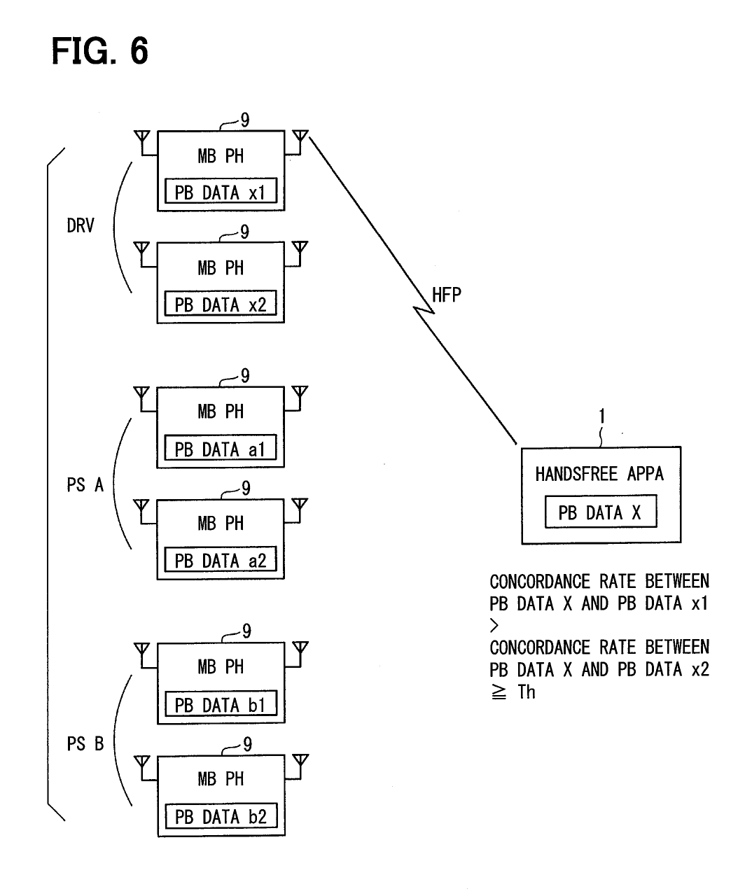

In the above description, HFP is connected between the BT connecting section 3 and multiple (two or more) communication devices simultaneously (multiple connection) as an example. When the BT connecting section 3 is limited to connect with multiple communication devices simultaneously (does not support multiple connection) under HFP, the BT connecting section 3 is able to connect with only one communication device under HFP. In this case, as shown in FIG. 6, when multiple communication devices have respective sets of phone book data, which have concordance rates equal to or higher than the threshold level, the BT connecting section 3 may be configured to connect with the one communication device, whose phone book data has the most high concordance rate, under HFP.

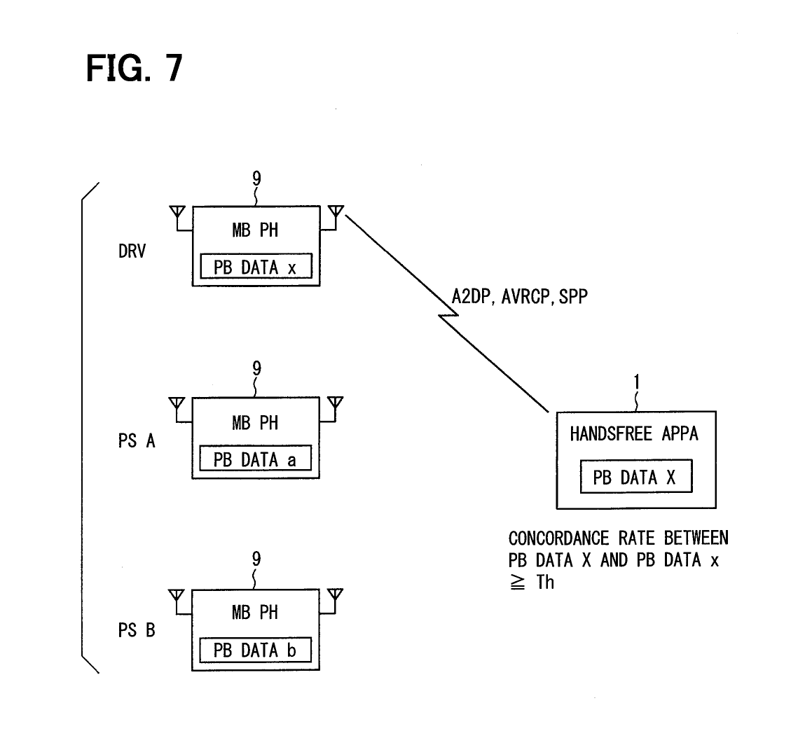

In the above description, HFP connection is carried out between the hands free apparatus 1 and the communication device whose phone book data has the concordance rate equal to or higher than the threshold level. As another example, other profiles (A2DP, AVRCP, SPP in FIG. 7) different from HFP can be connected between the hands free apparatus 1 and the communication device whose phone book data has the concordance rate equal to or higher than the threshold level. With this configuration, the mobile phone 9, whose phone book data has the concordance rate with the phone book data of the hands free apparatus equal to or higher than the threshold level, can work in cooperation with the hands free apparatus 1. For example, when A2DP or AVRCP is connected between the hands free apparatus 1 and the mobile phone 9, the music data stored in the mobile phone 9 can be transmitted to the hands free apparatus 1 and can be outputted from the speakers 12, 13. For example, when SPP is connected between the hands free apparatus 1 and the mobile phone 9, various data (such as schedule data) can be transmitted from the mobile phone 9 to the hands free apparatus 1 and can be displayed on the display section 15.

In order to indicate, to the user, the phone book data selected as the comparison target in a recognizable manner, the controller 2 may display, on the display section 15, information (user information under which the manager of the phone book data is recognizable) indicating which phone book data is set as the comparison target. The threshold level is a changeable value and the controller 2 may perform the change control. The threshold level may be changed according to an operation made by the user on the touch operation input section 16 or a speech made by a user under speech recognition technology. With this configuration, a condition for determining whether the concordance rate of the phone book data is equal to or higher than the threshold level can be controlled more strictly or more loosely. With this configuration, the number of the target communication devices with which the profile should be connected can be adjusted.

As described above, according to the present embodiment, the hands free apparatus 1 compares the phone book data acquired from the mobile phone 9 with which the BT line is in connected state with the phone book data stored in the own apparatus. When the concordance rate is equal to or higher than the threshold level, the hands free apparatus 1 connects with the mobile phone 9 under HFP. With this configuration, in a case where there exists multiple mobile phones with which the hands free apparatus 1 is connectable under HFP, the hands free apparatus 1 is able to easily specify, among the multiple mobile phones 9, the target mobile phone with which HFP connection should be carried out by determining whether the concordance rate of the phone book data of each mobile phone 9 is equal to or higher than the threshold level. With this configuration, HFP connection is properly carried out with the target mobile phone 9. Different from conventional art, under this configuration, storing of connection history is not required for the apparatus. Further, there is no need to store the owner information in the partner terminal device or in the near field wireless communication apparatus. Thus, a convenience for user is improved.

When there exists multiple mobile phones 9 each of which has the phone book data having concordance rate equal to or higher than the threshold level, HFP connection is carried out with each of the multiple mobile phones 9. Thus, when one user carries multiple mobile phones 9 and the phone book data of the multiple mobile phones 9 have similar records, a convenience for user is improved. As described above, the phone book data functions as the comparison target in the hands free apparatus 1 can be changed. Thus, the target mobile phones 9 with which HFP is to be connected can be changed easily by changing the phone book data functioning as the comparison target in the hands free apparatus 1. As described above, the threshold level with which the concordance rate of the phone book data is compared can be changed. With this configuration, a condition for determining whether the concordance rate of the phone book data is equal to or higher than the threshold level can be controlled more strictly or more loosely. Accordingly, the number of the target mobile phones 9 with which HFP connection is to be made can be freely changed.

When only the phone number is compared in the comparison of the phone book data (registration name is not compared), the mobile phone 9 may transmit only the phone numbers to the hands free apparatus 1 (without transmitting the registration names). Herein, the phone numbers is only a part of the phone book data. Thus, compared with a case in which the whole phone book data is transmitted to the hands free apparatus 1, a calculation time of the concordance rate can be reduced. With this configuration, a time required for determining whether to make HFP connection or not can be reduced, and the hands free function can be promptly used on the calls made or received by the mobile phone 9 having the concordance rate equal to or higher than the threshold level.

When predetermined protocol is connectable with multiple partner terminal devices, it is difficult to determine with which partner terminal device the predetermined protocol should be connected. In the present disclosure, since the phone book data stored in each of the partner terminal devices is different from one another, the partner terminal device, whose phone book data has the concordance rate equal to or higher than the threshold level, is designated as the target partner terminal device with which the predetermined protocol should be connected. With this configuration, the predetermined protocol can be connected with the target partner terminal device in simple manner. In this case, different from conventional art, storing of connection history is not required for the apparatus. Further, there is no need to store the owner information in the partner terminal device or in the near field wireless communication apparatus. Thus, a convenience for user is improved.

The present disclosure is not limited to the above-mentioned embodiment, and also includes the following modifications and extensions.

Under a condition that near field wireless communication apparatus is capable of storing the phone book data and is capable of connecting with a communication device whose phone book data has the concordance rate equal to or higher than the threshold level under a profile, an apparatus other than the hands free apparatus can be provided as the near field wireless communication apparatus.

When MAP is to be connected with the communication device whose phone book data has the concordance rate equal to or higher than the threshold level, only electronic mail address can be compared when comparing the phone book data of the communication device with the phone book data of the apparatus.

While the disclosure has been described with reference to preferred embodiments thereof, it is to be understood that the disclosure is not limited to the preferred embodiments and constructions. The disclosure is intended to cover various modification and equivalent arrangements. In addition, while the various combinations and configurations, which are preferred, other combinations and configurations, including more, less or only a single element, are also within the spirit and scope of the disclosure.

What is claimed is:

1. A near field wireless communication apparatus comprising:
a storage storing apparatus side phone book data;
a connecting section connectable with a partner terminal device under a predetermined protocol, wherein the partner terminal device stores device side phone book data; and
a controller
acquiring the device side phone book data from the partner terminal device under a condition that the partner terminal device is in a connectable state with the connecting section under the predetermined protocol,
comparing the device side phone book data with the apparatus side phone book data stored in the storage, and
when determining that a concordance rate between the device side phone book data and the apparatus side phone book data is equal to or higher than a threshold level, connecting the partner terminal device with the connecting section under the predetermined protocol.

2. The near field wireless communication apparatus according to claim 1, wherein
the connecting section is connectable with a plurality of partner terminal devices simultaneously under the predetermined protocol, the plurality of partner terminal devices include the partner terminal device,
the controller compares device side phone book data of each of the plurality of partner terminal devices with the apparatus side phone book data, and
when the controller determines that one or more of the plurality of terminal devices have respective device side phone book data and the concordance rate between the apparatus side phone book data and each of the device side phone book data of the one or more of the plurality of terminal devices is equal to or higher than the threshold level, the controller connects the one or more of the plurality of terminal devices with the connecting section under the predetermined protocol.

3. The near field wireless communication apparatus according to claim 1, wherein
the storage stores a plurality of apparatus side phone book data different from one another, the plurality of apparatus side phone book data include the apparatus side phone book data,
the controller selects one of the plurality of the apparatus side phone book data as a comparison target, and
the controller compares, with the comparison target, the device side phone book data acquired from the partner terminal device that is in the connectable state with the connecting section under the predetermined protocol.

4. The near field wireless communication apparatus according to claim 3, further comprising
an operation detector detecting an operation made by a user, wherein, when the operation detector detects the operation made by the user for selecting the comparison target, the controller selects the comparison target from the plurality of the apparatus side phone book data stored in the storage according to the operation made by the user.

5. The near field wireless communication apparatus according to claim 1, wherein
the threshold level is changeable by the controller.

6. The near field wireless communication apparatus according to claim 1, wherein
the controller compares at least one of a group of phone numbers or a group of mail addresses included in the device side phone book data acquired from the partner terminal device with at least one of a group of phone numbers or a group of mail addresses included in the apparatus side phone book data stored in the storage.

7. The near field wireless communication apparatus according to claim 1, wherein
the connecting section is connectable with the partner terminal device under a protocol for providing a hands free calling as the predetermined protocol, and
when the controller determines that the concordance rate between the device side phone book data and the apparatus side phone book data is equal to or higher than the threshold level, the controller connects the connecting section with the partner terminal device, which is determined to have the device side phone book data whose concordance rate is equal to or higher than the threshold level, under the protocol for providing the hands free calling.
